(19) United States
(12) Patent Application Publication
(10) Pub. No.: US 2026/0035032 A1
(43) Pub. Date: Feb. 5, 2026

(54) APPARATUS AND METHOD FOR STEERING ASSIST CONTROL, AND VEHICLE CONTROL SYSTEM INCLUDING THE SAME

(71) Applicant: HL MANDO CORPORATION, Gyeonggi-do (KR)

(72) Inventors: Tae Hyung SUN, Gyeonggi-do (KR); Tae Sik KIM, Gyeonggi-do (KR); Tae Yun KOO, Gyeonggi-do (KR)

(21) Appl. No.: 19/286,230

(22) Filed: Jul. 30, 2025

(30) Foreign Application Priority Data
Jul. 31, 2024 (KR) 10-2024-0101676
Jul. 28, 2025 (KR) 10-2025-0102470

(51) Int. Cl. B62D 5/04; B62D 15/02

(52) U.S. Cl. CPC B62D 5/0484; B62D 5/0463; B62D 15/0245

(57) ABSTRACT

An apparatus for steering assist control includes a memory storing at least one instruction, and at least one processor executing the at least one instruction, in which the at least one processor executes the at least one instruction to determine whether a front wheel steering device of a vehicle is faulty based on steering state information corresponding to the front wheel steering device, generate a locking control signal for the front wheel steering device to maintain a steering angle of a front wheel if the front wheel steering device is determined to be faulty, and generate cooperative control information for a rear wheel steering device in a state where the front wheel steering device is locked.

### CROSS-REFERENCE TO RELATED APPLICATION

This application claims the priority of Korean Patent Application Nos. 10-2024-0101676 and 10-2025-0102470 filed on Jul. 31, 2024 and filed on Jul. 28, 2025, in the Korean Intellectual Property Office, the disclosure of which is incorporated herein by reference in its entirety.

### BACKGROUND

### Field

The present embodiments relate to an apparatus and method for steering assist control to ensure steering stability.

### Description of the Related Art

With the recent development of a vehicle technology, various steering systems are being developed to improve traveling stability and steering responsiveness. In particular, a steering technology combining a front wheel steering system and rear wheel steering system is being widely adopted, and research is ongoing to reduce a turning radius of a vehicle and improve lane change stability during high-speed traveling.

The rear wheel steering system has the advantage of improving steering stability and maneuverability, but the rear wheel steering system has structural characteristics that are strongly dependent on the operating state of the front wheel steering device. Accordingly, if there is a problem with the front wheel steering device or normal control is not performed, the cooperative control of the rear wheel steering system may also be limited, which may affect the steering stability of the entire vehicle.

In addition, in situations where a steering direction of a driver changes abruptly, the steering response between the front and rear wheels may not be aligned, which may cause the vehicle behavior to become unstable. In particular, if the rear wheel steering device is controlled solely in a state of failure or delayed response of the front wheel steering device, it may be difficult to secure the steering direction consistency of the entire vehicle, which may hinder traveling stability.

To solve these problems, various research is being conducted on auxiliary control technologies that operate cooperatively depending on the status of the front and rear wheel steering devices, fixed/locking control technologies that can maintain a constant steering angle even in the event of a failure, and stabilization logic that responds to sudden changes in steering direction.

### SUMMARY

According to the background, the present disclosure seeks to provide an apparatus and method for steering assist control capable of flexibly responding to a change in a steering direction of a driver.

In order to solve the above-mentioned problem, in one aspect, the present disclosure provides an apparatus for steering assist control, the apparatus comprising:, one or more processors; and memory configured to store instructions that when executed on the one or more processors cause the one or more processors to perform operations comprising: determining whether a front wheel steering device of a vehicle is in a faulty state based on steering state information of the front wheel steering device, if the front wheel steering device is determined to be in the faulty state, generating a locking control signal for locking the front wheel steering device to maintain a steering angle of a front wheel, and generating cooperative control information for controlling a rear wheel steering device of the vehicle in a state where the front wheel steering device is locked.

In another aspect, the present disclosure provides a method performed by at least one processor included in an apparatus for steering assist control, the method comprising: determining whether a front wheel steering device of a vehicle is in a faulty state based on steering state information of the front wheel steering device; if the front wheel steering device is determined to be in the faulty state, generating a locking control signal for locking the front wheel steering device to maintain a steering angle of a front wheel; and generating cooperative control information for controlling a rear wheel steering device of the vehicle in a state where the front wheel steering device is locked.

In another aspect, the present disclosure provides a vehicle control system, comprising: a steering wheel configured to mechanically transmit steering input of a driver; a front wheel steering device configured to steer a front wheel; a rear wheel steering device configured to steer a rear wheel; a front wheel steering sensor configured to detect a steering state of the front wheel steering device; a rear wheel steering sensor configured to detect a steering state of the rear wheel steering device; a steering wheel sensor configured to detect a steering direction and a steering speed of the steering wheel; and an apparatus communicationally connected with the front wheel steering sensor, the rear wheel steering sensor, and the steering wheel sensor and configured to perform steering assist control, wherein the apparatus for the steering assist control is configured to determine whether the front wheel steering device is in a faulty state based on steering state information of the front wheel steering device, generate a locking control signal for locking the front wheel steering device to maintain a steering angle of the front wheel if the front wheel steering device is determined to be in the faulty state, and generate cooperative control information for controlling the rear wheel steering device in a state where the front wheel steering device is locked.

According to the present embodiments, it is possible to provide an apparatus and method for steering assist control for stably maintaining a steering angle intended by a driver.

The effects of the present disclosure are not limited to the aforementioned effects, and other effects, which are not mentioned above, will be apparently understood to a person having ordinary skill in the art from the following description.

The objects to be achieved by the present disclosure, the means for achieving the objects, and the effects of the present disclosure described above do not specify essential features of the claims, and, thus, the scope of the claims is not limited to the disclosure of the present disclosure.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a block diagram of an exemplary computing system that may be used in the present disclosure;

FIG. 2 is an exemplary flowchart illustrating a steering assist control process according to one embodiment of the present disclosure;

FIG. 3 is an exemplary diagram for explaining a situation in which a steering angle is not maintained and a turning behavior of a vehicle occurs abnormally in the event of the front wheel failure according to one embodiment of the present disclosure;

FIG. 4 is an exemplary diagram for explaining a situation in which a steering angle is maintained and a vehicle performs a normal turning behavior even in the event of the front wheel failure according to one embodiment of the present disclosure;

FIG. 5 is an exemplary diagram for explaining a process in which locking and cooperative control are performed in a straight-line traveling situation in the event of the front wheel failure according to one embodiment of the present disclosure;

FIG. 6 is an exemplary diagram for explaining a process in which locking and cooperative control are performed in a turning radius maintenance situation in the event of the front wheel failure according to one embodiment of the present disclosure;

FIG. 7 is an exemplary diagram for explaining a process of performing locking and subsequent cooperative control if a steering direction reversal occurs in the turning radius maintenance situation according to one embodiment of the present disclosure;

FIG. 8 is an exemplary flowchart illustrating an overall control process including cooperative control and locking control according to a straight-line or turning situation in the event of the front wheel failure according to one embodiment of the present disclosure; and

FIG. 9 is an exemplary flowchart illustrating a method for steering assist control according to one embodiment of the present disclosure.

FIG. 10 is a block diagram illustrating an exemplary configuration of an apparatus for steering assist control.

FIG. 11 is a block diagram illustrating an exemplary configuration of a front wheel steering device.

### DETAILED DESCRIPTION OF THE EMBODIMENT

In the following description of examples or embodiments of the present disclosure, reference will be made to the accompanying drawings in which it is illustrated by way of illustration specific examples or embodiments that can be implemented, and in which the same reference numerals and signs can be used to designate the same or like components even when they are illustrated in different accompanying drawings from one another. Further, in the following description of examples or embodiments of the present disclosure, detailed descriptions of well-known functions and components incorporated herein will be omitted when it is determined that the description may make the subject matter in some embodiments of the present disclosure rather unclear. The terms such as “including”, “having”, “containing”, “constituting”, “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements or the like, but is used merely to distinguish the corresponding element from other elements.

When it is mentioned that a first element “is connected or coupled to”, “contacts or overlaps” or the like a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, or the like each other via a fourth element. Here, the second element may be included in at least one of two or more elements that “are connected or coupled to”, “contact or overlap”, or the like each other.

When time relative terms, such as “after”, “subsequent to”, “next”, “before”, and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes or the like are mentioned, it should be considered that numerical values for an elements or features, or corresponding information (for example, level, range, or the like) include a tolerance or error range that may be caused by various factors (for example, process factors, internal or external impact, noise, or the like) even when a relevant description is not specified. Further, the term “may” fully encompass all the meanings of the term “can”.

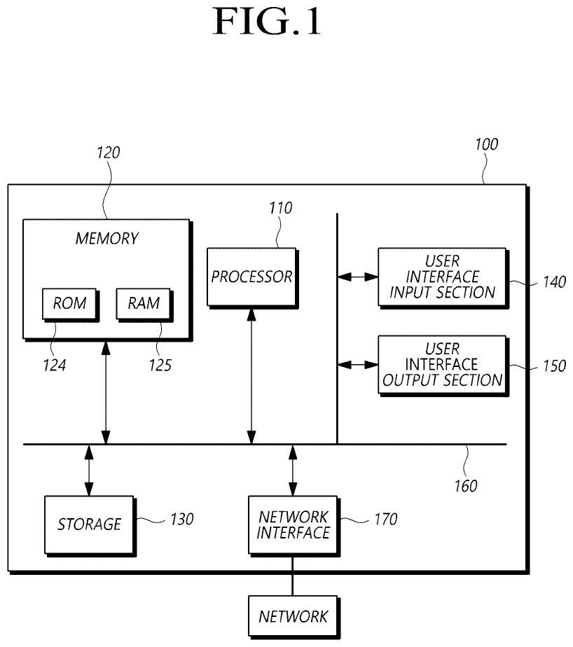

FIG. 1 is a block diagram of an exemplary computing system that may be used in the present disclosure.

Referring to FIG. 1, a computer system 100 may include one or more processors 110, a memory 120, a storage 130, a user interface input section 140, a user interface output section 150, a bus 160, and a network interface 170 in a form that reflects a hardware configuration of an apparatus for steering assist control.

The processor 110 may analyze a steering state of the vehicle and perform steering assist control. Specifically, if a failure of the front wheel steering device is detected, the processor 110 may generate a control signal so that a steering angle of a front wheel is fixed (for example, locked). In addition, the processor may generate a cooperative control signal for controlling a rear wheel steering device in a state where the steering angle of the front wheel is fixed so that rear wheel cooperative steering is performed. That is, the processor may control so that stable traveling is possible according to the steering direction of a driver based on the front wheel fixation and rear wheel cooperative steering even in a situation where the front wheel steering is impossible.

The memory 120 may include a ROM 124 and a RAM 125. For example, the ROM 124 may store a reference threshold, determination logic, algorithm, or the like required for locking control and cooperative control, and the RAM 125 may be used to temporarily store real-time operating data such as a steering angle, steering speed, driver steering direction, and locking status.

The storage 130 is a nonvolatile storage device for recording failure history, locking performance history, cooperative control performance results, driving pattern data, or the like, and may include a storage medium such as an SSD or eMMC.

The user interface input section 140 may receive diagnostic commands, system initialization, driver intervention, or the like, and the user interface output section 150 may perform the function of providing the driver with visual or auditory information such as fault detection, front wheel locking status, and rear wheel control status.

The bus 160 is a communication path for transmitting and receiving signals and data between components within the system, and the network interface 170 may transmit and receive control signals by linking with an external ECU, such as an RWS controller or a vehicle integrated controller, through an in-vehicle communication network (controller area network (CAN), or the like).

The computer system 100 according to the present disclosure may perform the locking control of the front wheel steering device and the cooperative control of the rear wheel steering device in conjunction to maintain steering stability and responsiveness of the vehicle even in the front wheel steering failure situation. Through this, steering performance that meets a driver's intention may be secured.

In general, in a state where the front wheel steering device fails, the steering performance of the vehicle deteriorates rapidly, and it is difficult to secure stability under various traveling conditions by simply fixing the front wheels.

The apparatus for steering assist control of the present disclosure dynamically performs unlocking and re-locking of the front wheel steering device according to the steering direction of the driver and the vehicle traveling state, and performs cooperative control for the rear wheel steering device in parallel, thereby supporting stable traveling in various steering situations such as curve traveling, reverse steering, and holding of straight-line motion.

The computing system according to the present disclosure may be connected to a server system. For example, the server system may be connected to the computing system according to the present disclosure wired or wirelessly through a network to transmit and receive data and share computing resources.

For example, the server system may be built in the form of a cloud system. For example, the server system may include a configuration that allows individual computing devices to access the server system through a network and share computing resources with the connected computing devices. In this case, the individual computing devices may access the cloud system from anywhere in an environment connected to a network such as the Internet.

For example, the cloud system may flexibly expand or contract computing resources as needed, and share these computing resources with other computing devices connected to the network. In addition, the cloud system may be built based on various service models such as infrastructure as a service (IaaS), platform as a service (PaaS), and software as a service (SaaS) depending on the purpose or scope of use.

For example, the cloud system may include at least one computing device, storage device, and network device, respectively. Each computing device included in the cloud system may include a processor and a memory to process various computing tasks, and the storage device may include a configuration related to data storage, such as a hard disk drive (HDD), a solid state drive (SSD), a network attached storage (NAS), or a storage area network (SAN), for storing large amounts of data, and the network device may include a networking-related configuration, such as a switch, a router, a load balancer, and a firewall.

For example, the computing system may use an artificial intelligence model stored in the memory of the computing system to perform various operations, or classification and generation of data, using an artificial intelligence model.

Alternatively, in some cases, the computing system may share the computing resources from the cloud system and utilize an artificial intelligence model stored in the cloud system. In this case, even if the computing system does not directly own the configuration related to the artificial intelligence model, it is possible to process related tasks by utilizing the artificial intelligence model provided by the cloud system.

The processes, systems and methods described herein can be implemented by the computing system in response to the processor executing an arrangement of instructions contained in main memory. Such instructions can be read into main memory from another computer-readable medium, such as the storage device. Execution of the arrangement of instructions contained in main memory causes the computing system to perform the illustrative processes described herein. One or more processors in a multiprocessing arrangement may also be employed to execute the instructions contained in main memory. Hard-wired circuitry can be used in place of or in combination with software instructions together with the systems and methods described herein. Systems and methods described herein are not limited to any specific combination of hardware circuitry and software.

Although an example computing system has been described, the subject matter including the operations described in this specification can be implemented in other types of digital electronic circuitry, or in computer software, firmware, or hardware, including the structures disclosed in this specification and their structural equivalents, or in combinations of one or more of them.

The terms “data processing system”, “computing device”, “component”, or “data processing apparatus” encompass various apparatuses, devices, and machines for processing data, including by way of example a programmable processor, a computer, a system on a chip, or multiple ones, or combinations of the foregoing. The apparatus can include special-purpose logic circuitry, for example, an FPGA (field-programmable gate array) or an ASIC (application-specific integrated circuit). The apparatus can also include, in addition to hardware, code that creates an execution environment for the computer program in question, for example, code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. The components of system can include or share one or more data processing apparatuses, systems, computing devices, or processors.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (for example, one or more scripts stored in a markup language document), in a single file dedicated to the program in question, or in multiple coordinated files (for example, files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs (for example, components of the data processing system) to perform actions by operating on input data and generating output. The processes and logic flows can also be performed by, and apparatuses can also be implemented as, special purpose logic circuitry, for example, an FPGA (field-programmable gate array) or an ASIC (application-specific integrated circuit). Devices suitable for storing computer program instructions and data include all forms of non-volatile memory, media and memory devices, including by way of example semiconductor memory devices, for example, EPROM, EEPROM, and flash memory devices; magnetic disks, for example, internal hard disks or removable disks; magneto optical disks; and CD ROM and DVD-ROM disks. The processor and the memory can be supplemented by, or incorporated in, special purpose logic circuitry.

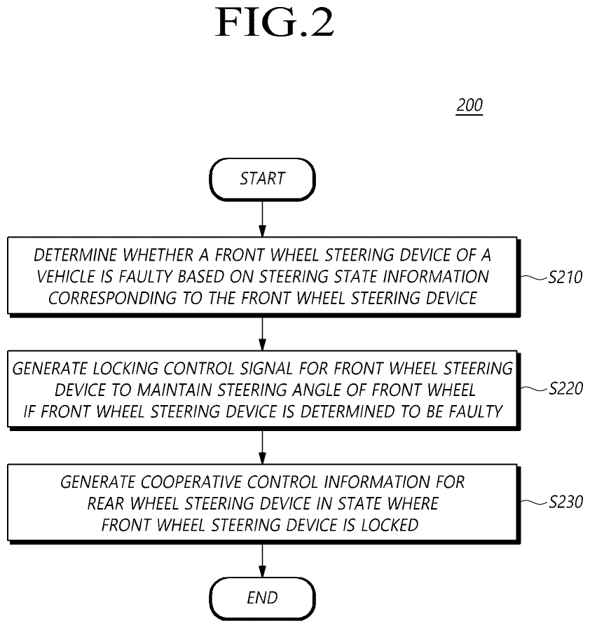

Hereinafter, with reference to FIGS. 2 to 10, a detailed description will be given of specific operation procedures of a steering assist control process performed by a processor of the apparatus for steering assist control according to the present disclosure.

FIG. 2 is an exemplary flowchart illustrating a steering assist control process 200 according to one embodiment of the present disclosure.

According to one embodiment of the present disclosure, the processor may determine whether a front wheel steering device of a vehicle is faulty based on steering state information corresponding to the front wheel steering device in S210.

In the embodiment, the steering state information is information that reflects the operating state of the front wheel steering device in real time and may include a plurality of steering-related signals corresponding to the front wheel steering device. For example, the steering state information may include, but is not limited to, a steering angle, a steering speed, a current or voltage applied to a front wheel steering motor, an output value of a steering angle sensor, information on a deviation of an actual steering angle compared to a target steering angle, and information on the duration of the corresponding deviation.

The steering state information may be collected in real time through an electronic control unit (ECU) of the vehicle, front wheel steering motor driver, steering angle sensor, current sensor, and position sensor, and the collected steering state information is periodically evaluated by the processor. The steering state information is used to diagnose the responsiveness of the front wheel steering device, whether it is operating normally, and the suitability of the response to the control signal.

According to an embodiment, the processor may determine whether the front wheel steering device is faulty by comparing the received steering state information with a preset threshold. For example, the processor may determine that a steering response delay or an uncontrollability condition exists by detecting that a deviation between a target steering angle and an actual steering angle exceeds a tolerance range or that the deviation persists for a predetermined period of time.

In addition, for example, if the current or voltage value applied to the steering motor increases abnormally, or if a feedback response to a control command is not received, this may be identified as a sign of a failure. Based on the analysis results, the processor may finally determine that the front wheel steering device is not operating normally, that is, it is in a failure state.

According to one embodiment of the present disclosure, the processor may generate a locking control signal for the front wheel steering device to maintain the steering angle of the front wheel if the front wheel steering device is determined to be faulty in S220.

In an embodiment, the locking control signal is a control command for maintaining the front wheel steering angle fixed, and is a control signal for mechanically or electrically fixing the drive motor. The locking operation corresponding to the locking control signal is to prevent the steering angle from changing unintentionally if the front wheels fail, so as to stably maintain the steering direction set by the driver without slipping.

According to one embodiment, the front wheel steering device (for example, a rack wheel actuator (RWA)) may control the steering direction of the front wheel by generating a steering force based on a drive motor. In this case, if a transition to a safety state of a system (for example, a vehicle integrated control system) is required or an unexpected system failure occurs, a situation may occur in which the drive motor of the front wheel steering device intentionally or unintentionally stops driving.

More specifically, if a motor open fault is detected or a motor off is performed by a safety mechanism for system protection, the electrical drive torque applied to the drive motor may be removed. This leaves a motor shaft electrically or mechanically unfixed, resulting in the steering shaft being free to rotate without external steering force.

This condition is generally referred to as a free rolling state, and refers to a situation where the steering shaft may rotate arbitrarily due to an external force (for example, road surface irregularities, rear wheel cooperative steering force, or the like) without any steering torque being applied. If the free rolling state is maintained, the front wheel steering angle may change regardless of the driver's intention, so separate measures are required to ensure stable vehicle behavior.

That is, the free rolling state of the front wheel is regarded as a loss of steering angle maintenance control, and especially if rear wheel cooperative steering is performed simultaneously, it may cause confusion in the turning behavior of the entire vehicle.

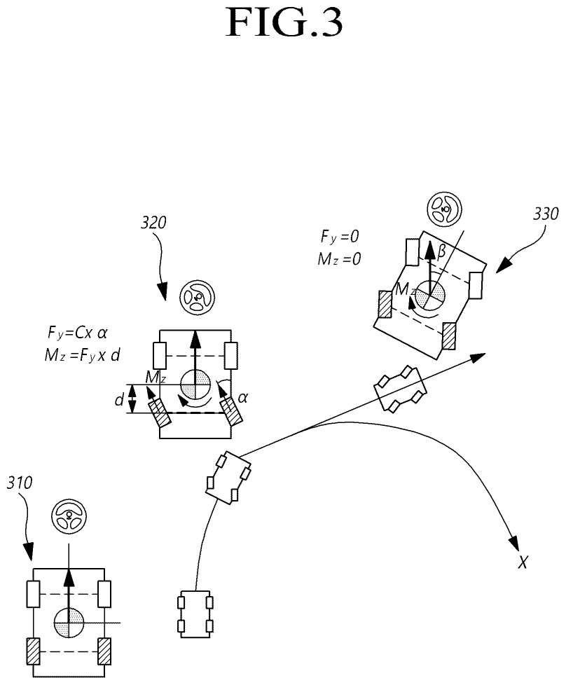

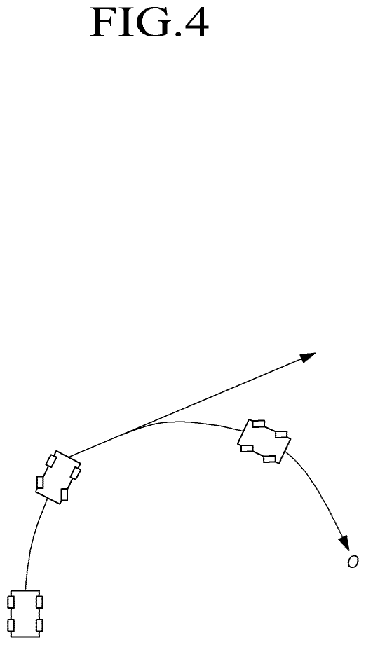

FIG. 3 is an exemplary diagram for explaining a situation in which a steering angle is not maintained and a turning behavior of a vehicle occurs abnormally in the event of the front wheel failure according to one embodiment of the present disclosure. FIG. 4 is an exemplary diagram for explaining a situation in which the steering angle is maintained and the vehicle performs a normal turning behavior even in the event of the front wheel failure according to one embodiment of the present disclosure.

Referring to FIG. 3, in a situation where the vehicle is traveling along a certain turning path, a failure of the front wheel steering device occurs, and as a result, the front wheel steering angle is not fixed and the free rolling state occurs. In this state, if the rear wheel cooperative steering operates normally, as a first state 310 changes to a second state 320, a lateral force is applied to the rear of the vehicle by the steering of the rear wheels, and a turning moment of the vehicle is generated based on this.

More specifically, if the front wheels are in the free rolling state, the steering angle is not maintained and may rotate arbitrarily depending on external influences, so the lateral force (Fy) that should occur in the front tires is not properly formed. This can drastically deteriorate the steering stability of the entire vehicle.

Fy=C×α

Here, Fy represents a lateral force generated by a tire, C represents a tire cornering stiffness, and α represents a tire slip angle.

The above Expression indicates that if a slip angle of the tire exists, the lateral force acting as a restoring force is generated through elastic deformation of the tire rubber. That is, if the steering angle is fixed and a constant slip angle is maintained, the tire may generate sufficient Fy to maintain the turning path.

Mz=Fy×d

The above Expression illustrates that a turning moment Mz is generated by the lateral force Fy, causing the vehicle to rotate around a center of mass of the vehicle.

Here, d is a distance between the point where the rear wheel is located and the center of the vehicle.

That is, if a constant slip angle α is formed due to the rear wheel cooperative steering, a lateral force Fy is generated at the rear wheel, and since the generated force acts at a location away from the vehicle center, the turning moment Mz is induced. This turning moment becomes the dynamic basis for enabling the vehicle to turn in the intended direction.

Meanwhile, when the front wheel is in the free rolling state, the front wheel slip angle α is not maintained and converges to 0, which causes the Fy of the front wheel to substantially decrease or disappear. As a result, the Mz of the entire vehicle is not effectively generated, and the vehicle may lose turning power and exhibit unintended straightness or abnormal turning behavior (for example, understeering, directional instability, overshoot, or the like) as in a third state 330.

For example, if the front wheel steering device suddenly fails while the vehicle is turning at high speed and the free rolling state is maintained, the front wheels will not respond as much as the turning moment generated by the rear wheels. In this case, the driver will experience the vehicle turning more aggressively than expected (overshoot) or not turning enough, resulting in a wider turning radius (understeering). This situation may lead to accidents, especially in ramp entrance sections of urban highways, sharp curve sections, or during high-speed evasive maneuvers.

One embodiment of the present disclosure includes a locking control method for maintaining the steering angle even if the front wheel steering device fails, as illustrated in FIG. 4. Referring to FIG. 4, the steering shaft is fixed by a mechanical or electromagnetic locking device so that the front wheel is not transitioned to the free rolling state, and thus a slip angle is stably maintained. As a result, the lateral force may be continuously generated at the front tire, and as a result, the turning moment of the vehicle is also normally maintained.

That is, if the locking control according to the present disclosure is applied, the vehicle maintains the intended steering angle even if the front wheel failure occurs, and the stability of the overall turning behavior may be secured through combination with the rear wheel cooperative steering. This provides the effect of ensuring the predictability of vehicle behavior and steering responsiveness even in a steering device failure situation, thereby enabling path maintenance and evasive maneuvers that are in line with the driver's intention even during high-speed driving.

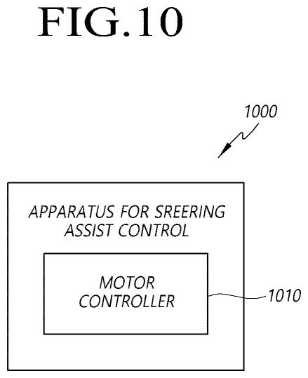

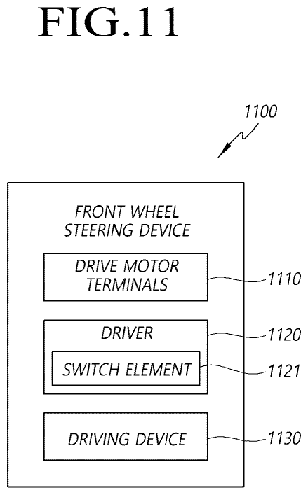

Referring to FIGS. 10 and 11, according to one embodiment, the apparatus 1000 for steering assist control may further include a motor controller 1010 that receives the locking control signal and performs the locking operation for the front wheel steering device 1100.

In an embodiment, the motor controller 1010 may form a resistance between the drive motor terminals1110 of the front wheel steering device 1100 according to electrical control, and control the steering position of the front wheel to be maintained by the rotational resistance generated through the resistance.

The motor controller may induce intentional rotational resistance by forming a variable resistance or fixed resistance component between the terminals of the drive motor included in the front wheel steering device according to the electrical control method. Specifically, the motor controller sets the drive motor to a generator mode or an electric brake mode so that a certain level of resistance torque is generated in response to the electromotive force generated when the steering shaft rotates. This configuration allows the steering position to be passively maintained by the braking force due to the electrical resistance acting as a counteraction if the steering shaft is to be rotated by an external force. Through this, it is possible to suppress unstable steering angle changes that may occur in the free rolling state.

For example, the motor controller may be a magneto-rheological (MR) controller. The MR controller may control the rotational resistance torque by variably adjusting the viscosity of a magneto-rheological fluid (MR fluid) according to an electromagnetic field.

In an embodiment, the MR controller may include a coil, a stator, a rotor, a disk, and an MR fluid. If a current is applied to the coil, a magnetic field is generated, which increases the viscosity of the MR fluid. This increases the resistance to rotation of the disk between the rotor and the stator, thereby generating a constant torque.

That is, if the drive motor is to be rotated by an external force, the rotation of the drive motor is suppressed due to the increase in viscosity of the MR fluid, thereby providing a locking effect.

In addition, according to an embodiment, the locking control signal may include an element control signal for controlling a switch element included in the drivers 1120 of the front wheel steering device to a conductive state. For example, the switch element may be implemented by including a metal oxide semiconductor field effect transistor (MOSFET), an insulated gate bipolar transistor (IGBT), a relay, or the like, and serves to short-circuit between terminals of the drive motor.

In this case, the processor may transmit an element control signal to a driving device 1130 corresponding to the switch element. The driving device 1130 may include one or more electronic components, such as a driver IC, a power transistor, or a relay circuit, configured to selectively activate or deactivate the switch element based on the control signal received from the processor. Specifically, the processor may generate an element control signal for controlling the switch element to be maintained in a conducting state if a locking condition is satisfied according to the steering assist control logic, and transmit the element control signal to a driver corresponding to the switch element.

If the switch element is energized, an electrical short circuit is formed between the terminals of the drive motor, or a closed-circuit state with a very low resistance value is formed, so that rotational resistance is induced by the internal winding of the motor. This electric brake (resistance locking) operation suppresses the drive motor from being arbitrarily rotated by an external force, and consequently provides the effect of maintaining the steering position above a certain level. The locking operation through the energization of the switch element may provide rapid response and constant rotational restraint without a separate mechanical fixing device, and may effectively contribute to securing the turning stability of the vehicle in the event of a failure of the front wheel steering device.

According to one embodiment of the present disclosure, the processor may generate cooperative control information for the rear wheel steering device in a state where the front wheel steering device is locked in S230.

Specifically, the processor may determine a rear wheel steering angle based on the current traveling situation of the vehicle (for example, speed, steering direction, turning radius, or the like) and output cooperative control information including a steering angle command to the rear wheel steering device.

For example, in a case where the front wheels are locked in a state of being steered to the left, even if the driver attempts to steer to the right to reduce the turning radius of the vehicle, the front wheels will no longer accept the steering angle change, so the steering intention will not be reflected. In this situation, the processor may perform reverse steering control to steer the rear wheels in the direction (left) opposite to the steering direction (right) of the driver.

That is, by controlling the rear wheels in the opposite direction in response to the turning path left by the fixed front wheel steering angle, a turning moment (Mz) of the vehicle may be actively increased to maintain or restore the intended rotation direction. The reverse control of the rear wheels may reduce dangerous behaviors such as understeer or straight-line deviation of the vehicle even if the front wheels are unable to steer.

According to one embodiment, the processor may compare and analyze a steering wheel operation direction of the driver and the front wheel locking status, and then, if a mismatch is detected between the two, generate the cooperative control information to steer the rear wheels in the direction opposite to the operation direction.

In addition, in an embodiment, the processor may dynamically adjust whether to apply rear wheel steering, the control method (in-phase or reverse phase), and the steering angle size by comprehensively considering changes in vehicle speed, lateral acceleration, steering torque, road friction conditions, and sensor input values before and after the locking state.

For example, if the vehicle speed decreases rapidly and the lateral acceleration decreases rapidly immediately after the front wheels are locked, this may be a signal that the vehicle is likely to lose turning ability and deviate in the straight direction. In this situation, the processor may apply the reverse control to steer the rear wheels in the direction opposite to the front wheel steering angle to reinforce the turning moment of the vehicle and restore the turning behavior.

For another example, if the road surface friction coefficient is determined to be low (for example, icy, wet, or the like), abrupt rear wheel steering may destabilize vehicle behavior, so the processor may limit the rear wheel steering angle or ease the steering speed to induce a smooth vehicle response.

As still another example, if steering torque is observed in the direction opposite to the steering direction of the driver (for example, the driver is attempting to steer right in a state where the front wheels are locked to the left), the processor may compensate for this mismatch by controlling the rear wheels in the direction opposite to the steering direction of the driver to compensate for steering responsiveness of the vehicle.

As described above, the processor may perform the rear wheel cooperative control even in the front wheel failure situation by comprehensively analyzing various sensor information and reflecting a dynamic state of the vehicle and driver's intention in real time. This allows the vehicle to prevent abnormal behavior and maintain a safer and more stable traveling state.

In various embodiments, the processor may variably adjust the control amount of cooperative control information for the rear wheel steering device depending on vehicle speed or whether the lane keeping function is activated.

More specifically, the processor may set the rear wheel steering angle to be large in order to reduce the turning radius and improve turning responsiveness if the vehicle speed is relatively low. Meanwhile, during high-speed traveling, the rear wheel steering angle may be small or cooperative control may be performed in a limited manner in order to give priority to the steering stability.

In addition, if the lane keeping assist (LKA) system is activated, the rear wheel steering control amount may be adjusted more precisely to reduce the risk of the vehicle leaving the lane. For example, if the front wheels are locked and lane keeping control is performed simultaneously, the processor may determine the degree of departure from the current lane center based on camera and sensor data, and control the rear wheel steering angle based on the departure information to prevent the vehicle from leaving the lane.

The aforementioned method enables precise rear wheel steering control that takes into account both longitudinal and lateral stability of the vehicle even in abnormal situations such as front wheel locking, and contributes to preventing accidents that may occur, especially during high-speed traveling.

In addition, according to an embodiment, the processor may classify the traveling situation based on steering angle information of the vehicle, and differentially generate the cooperative control information for the rear wheel steering device according to the classified traveling situation.

In an embodiment, the steering angle information is obtained based on a steering angle sensor signal received from a steering sensor or a vehicle control network, and may include information such as a current rotation angle of the steering wheel, a rotation direction, a rotation speed, and an accumulated rotation number. The processor may receive the steering angle information in real time, and analyze the steering angle information updated at regular time intervals to determine a steering pattern during traveling.

Specifically, the processor may classify the traveling situation as a straight-line traveling situation if the absolute value of the steering angle of the vehicle is less than a first threshold.

According to an embodiment, the processor may generate cooperative control information for the rear wheel steering device to correspond to the steering direction of the driver if the traveling situation is classified as a straight-line traveling situation.

For example, if the absolute value of the steering angle of the vehicle is less than a first threshold (for example, 3 degrees), the processor may classify the traveling situation as the straight-line traveling situation and generate the cooperative control information to reduce or deactivate the rear wheel steering control.

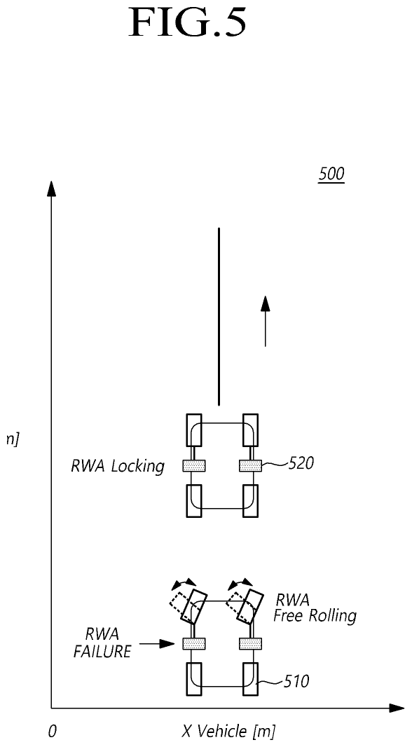

FIG. 5 is an exemplary diagram for explaining a process 500 in which the locking and cooperative control are performed in the straight-line traveling situation in the event of the front wheel failure according to one embodiment of the present disclosure.

Referring to FIG. 5, if a failure occurs in the front wheel steering device while the vehicle is traveling straight forward and the vehicle reaches a first state 510, the front wheels may enter a free rolling state in which steering control is impossible.

In this case, the processor determines that the absolute value of the steering angle of the vehicle is less than the first threshold (for example, 3 degrees), classifies the traveling situation as the straight-line traveling situation, and performs locking control for the front wheel steering device as in a second state 520 of FIG. 5, while generating the cooperative control information for the rear wheel steering device. Specifically, the processor may generate the cooperative control information in the direction of converging the rear wheel steering angle to 0 degrees or limiting the operation of the rear wheel steering device.

This may suppress unintentional vehicle behavior due to the steering assist control, and reduce vehicle trajectory deviation and unstable vibration phenomena even in high-speed straight sections or if the lane keeping assist system is activated.

Additionally, the processor may classify the traveling situation as a turning radius maintenance situation if the absolute value of the steering angle of the vehicle is equal to or more than the first threshold and less than a second threshold.

According to one embodiment, the processor may generate the cooperative control information for the rear wheel steering device to correspond to the steering direction of the driver if the traveling situation is classified as the turning radius maintenance situation.

For example, if the absolute value of the steering angle is equal to or more than a first threshold (for example, 3 degrees) and less than the second threshold (for example, 20 degrees), the processor may generate the cooperative control signal to apply steer-by-wire control to the rear wheels so as to maintain a turning radius.

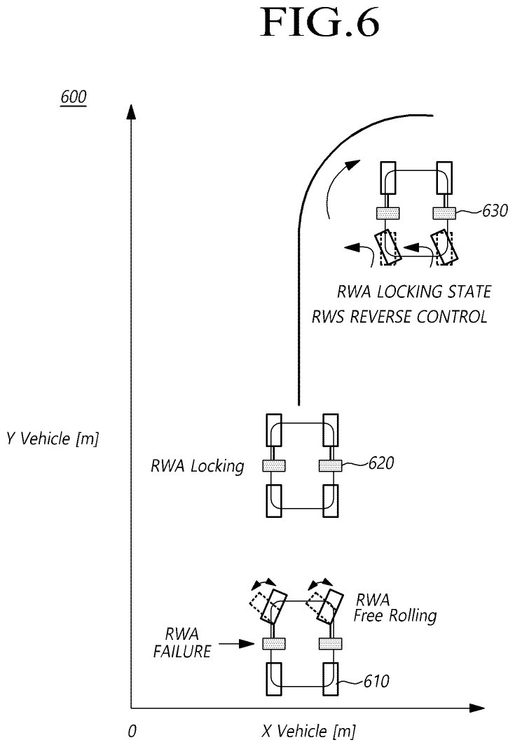

FIG. 6 is an exemplary diagram for explaining a process 600 in which the locking and cooperative control are performed in a turning radius maintenance situation in the event of the front wheel failure according to one embodiment of the present disclosure.

Referring to FIG. 6, if a failure occurs in the front wheel steering device in a turning situation and the vehicle reaches a first state 610, the front wheels may enter the free rolling state in which steering control is impossible.

The processor may determine that the absolute value of the steering angle of the vehicle is equal to or more than a first threshold (for example, 3 degrees) and less than a second threshold (for example, 20 degrees), classify the traveling situation as the turning radius maintenance situation, and perform locking control on the front wheel steering device as in a second state 620 of FIG. 6. In addition, the processor performs reverse control on the rear wheel steering device (that is, generates cooperative control information) in a state where the front wheels are locked, so that the vehicle is maintained in a third state 630.

More specifically, the processor may prevent steering response delay and abnormal vibration by performing locking control on the front wheel steering device to fix the steering angle after detecting that the front wheel steering device has transitioned to the free rolling state. In addition, the processor may generate the cooperative control information so that the vehicle may continue stable curve traveling while maintaining the intended turning radius by performing the reverse control for controlling the steering angle of the rear wheel steering device in the direction opposite to the steering direction of the driver in a state where the front wheels are locked.

Through this, even if the front wheel steering device fails and becomes uncontrollable, the turning radius of the vehicle may be prevented from increasing excessively or the trajectory may be prevented from being deviated, and the actual auxiliary steering function may be performed through the rear wheel steering device. In other words, the longitudinal and lateral stability of the vehicle may be improved, and the vehicle behavior may be maintained in accordance with the driver's steering intention.

In addition, the processor obtains steering speed information corresponding to the steering wheel in the cooperative control process corresponding to the cooperative control information, determines whether the steering direction of the driver is reversed based on the steering speed information, and if it is determined that the steering direction of the driver is reversed, the processor may generate the subsequent cooperative control information to respond to the reversal of the steering direction.

The steering speed information may include information on the rotation direction and the rotation speed of the steering wheel. For example, the steering speed information may include information on the rate of increase in the rotation angle of the steering wheel (the amount of change per unit time) and information on the sign of the rotation direction (for example, clockwise is a negative number, counterclockwise is a positive number, or the like).

In one embodiment, the processor may determine that the steering direction of the driver has been reversed. Specifically, the processor may determine whether the steering direction of the driver has been reversed based on whether the sign of the steering speed information has transitioned from positive to negative, or from negative to positive.

For example, if the sign of the steering speed information is transitioned from positive to negative, or vice versa, from negative to positive, the processor may determine that the steering direction of the driver has been reversed. This determination may be useful in situations where the driver abruptly changes the steering direction while turning, such as a case where a traveling trajectory of the vehicle changes due to continuous steering input (such as zigzag traveling or emergency evasive maneuvers).

The processor detects in real time whether the steering direction has been reversed and generates subsequent cooperative control information based on the detection results, so that the rear wheel steering device may be quickly adjusted to match the driver's new steering direction.

In one embodiment, the subsequent cooperative control information may be used to reset the control target of the rear wheel steering device, including the direction and magnitude of the change in steering angle.

Additionally, in an embodiment, the processor may generate an unlocking signal to temporarily deactivate locking control for the front wheel steering device in a case where the steering direction of the driver is determined to be reversed.

The unlocking signal may be generated in a traveling situation where the steering direction changes abruptly or the turning radius needs to be transitioned. This is to temporarily allow a change in the front wheel steering angle to enable a flexible transition in direction, since it may be difficult to control the vehicle behavior in a state where the front wheel steering angle is fixed. The unlocking signal may be transmitted to the front wheel steering device to allow a change in the steering angle of the front wheel steering device for a certain period of time.

In various embodiments, after generating the locking control signal for the front wheel steering device, the processor may determine whether the steering direction has been reversed and how long the reversal in the steering direction has persisted, and generate the unlocking signal to deactivate the locking control only if the steering reversal has persisted for a certain period of time or longer.

Specifically, the processor may determine whether the sign of the steering speed information continues to remain in a reversed state for a certain period of time. In this case, the certain period of time may be set as a preset reference time and is used as a threshold to prevent unnecessary unlocking due to a temporary change in steering direction.

For example, if the sign of the steering speed information is transitioned from positive to negative and then maintains a negative sign for a certain period of time (for example, 0.5 seconds or more), it may be determined that the steering direction of the driver has actually been reversed.

Only in this case will the processor generate the unlocking signal to unlock the front wheel steering device. Accordingly, by distinguishing between a situation where the steering direction of the driver changes momentarily and a situation where the steering direction is actually reversed and a new turning path is required, it is possible to prevent unnecessary control signal generation and improve the stability and reliability of the control system.

Additionally, the processor may generate the subsequent cooperative control information to control the rear wheel steering device in the direction opposite to the steering direction of the driver to compensate for the vehicle's turning behavior due to the steering direction reversal.

In one embodiment, the processor may analyze traveling data such as the steering speed information, vehicle speed, lateral acceleration, and yaw rate after a time point of reversal of the steering direction, to determine a control direction and a control amount for the rear wheel steering device so that the turning behavior of the vehicle follows a stable path. In this case, the subsequent cooperative control information may be transmitted to the rear wheel steering device to adjust the steering angle in the direction opposite to the steering direction of the driver, thereby compensating for the vehicle's center of rotation and improving traveling stability.

Additionally, the processor may generate a locking resumption signal to resume locking control for the front wheel steering device if it is determined that the front wheel steering device has reached a steering state in the opposite direction to the rear wheel steering device. The locking resumption signal is transmitted to the front wheel steering device to help restore steering stability of the vehicle by fixing the front wheel steering angle to the current state.

According to one embodiment, the processor may determine that the front wheel steering device has reached the steering state in the opposite direction to the rear wheel steering device if it is determined that the signs of the steering angle of the front wheel steering device and the steering angle of the rear wheel steering device are opposite to each other and that the difference between the absolute values corresponding to each steering angle is equal to or more than a preset reference value.

For example, if the rear wheel steering angle is −7 degrees and the front wheel steering angle is +13 degrees, the two steering angles have opposite signs and the absolute value difference is 6 degrees, so it is determined to be more than the reference value, and the conditions for resuming locking control of the front wheel steering device may be met.

That is, if the processor determines that the reverse cooperative control of the rear wheel steering device is completed, it may verify that the steering states of the front and rear wheels are in opposite directions, and perform locking of the front wheels again based on the verification result. This makes it possible to stably control the turning radius of the vehicle and ensure consistency in steering behavior.

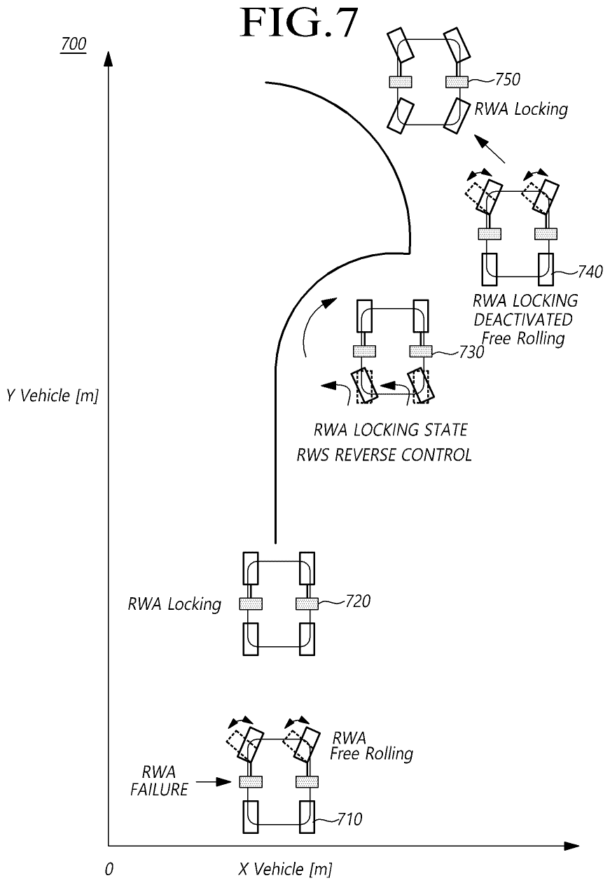

FIG. 7 is an exemplary diagram for explaining a process 700 of performing the locking and subsequent cooperative control if the steering direction reversal occurs in the turning radius maintenance situation according to one embodiment of the present disclosure.

Referring to FIG. 7, while the vehicle is traveling along the turning radius, a series of unlocking, subsequent cooperative control, and locking resumption processes are sequentially performed as the steering direction of the driver is reversed. Hereinafter, the vehicle states at each point in time while the vehicle is traveling are described by dividing them into a first state 710 to a fifth state 750.

In the first state 710, a failure occurs in the front wheel steering device, causing the front wheels to transition into the free rolling state. As a result, the steering angle of the front wheel is not fixed, and the steering control becomes impossible.

In the second state 720, the locking control is performed on the front wheel steering device by the locking control signal generated by the processor, and the front wheel steering angle is fixed to a constant state.

In the third state 730, the reverse cooperative control is performed for steering the rear wheel steering device in the direction opposite to the steering direction of the driver. That is, the reverse control is performed for the rear wheels in a state where the front wheels are fixed.

In the fourth state 740, the steering direction of the driver is determined to be reversed, and the processor generates the unlocking signal for the front wheel steering device. The front wheels are transitioned to the free rolling state again, allowing the change in the steering angle. In addition, in response to the unlocking point, the processor again performs the reverse cooperative control for the rear wheel steering device.

In the fifth state 750, while the reverse cooperative control for the rear wheel steering device is continuously performed, if the front wheel steering angle and the rear wheel steering angle face opposite directions and the difference between them becomes greater than the reference value, the processor generates the locking resumption signal for the front wheel steering device. Accordingly, the front wheels are fixed again in the current steering angle state, and the steering stability of the vehicle is restored.

That is, the control method according to the present embodiment may maintain the turning radius of the vehicle through the reverse cooperative control of the rear wheel steering device even in a steering failure state due to a failure of the front wheel steering device, and may continuously secure the steering performance and traveling stability of the vehicle even in the failure state by temporarily deactivating the front wheel locking and performing subsequent control and then resuming the locking if the steering stability is restored even in a special situation where the steering direction of the driver is reversed.

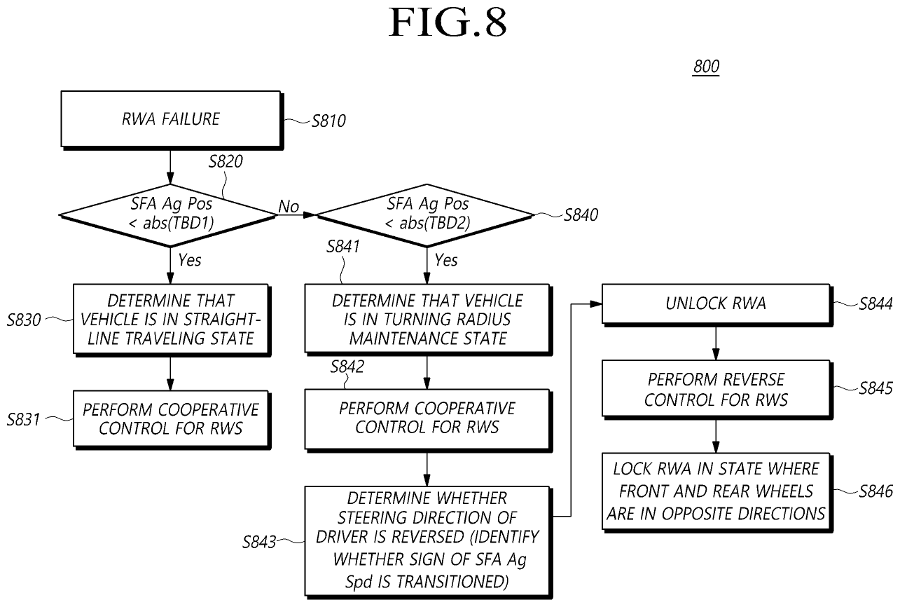

FIG. 8 is an exemplary flowchart illustrating an overall control process 800 including cooperative control and locking control according to the straight-line or turning situation in the event of the front wheel failure according to one embodiment of the present disclosure.

Referring to FIG. 8, the processor detects whether the front wheel steering device (RWA) is faulty in Step S810. Thereafter, the processor may determine whether a front wheel steering angle (SFA Ag Pos) is less than an absolute value (abs(TBD1)) of the first reference value in Step S820, and if the front wheel steering angle is less than the first reference value, proceed to Step S830 to determine that the vehicle is in the straight-line traveling state, and then perform cooperative control for the rear wheel steering device (RWS) in Step S831.

Meanwhile, if the determination result in Step S820 illustrates that the front wheel steering angle is equal to or more than the absolute value of the first reference value, the processor may additionally determine that the front wheel steering angle is less than an absolute value (abs(TBD2)) of the second reference value in Step S840. If the front wheel steering angle is less than the absolute value (abs(TBD2)) of the second reference value, the process proceeds to Step S841 to determine that the vehicle is in a state of maintaining the turning radius, and performs corresponding RWS cooperative control in Step S842. Subsequently, the processor determines whether the steering direction of the driver is reversed by identifying whether the sign of the front wheel steering speed (SFA Ag Spd) is transitioned in Step S843.

If the steering direction reversal is detected, the processor generates the control signal (that is, unlocking signal) for unlocking the front wheels in Step S844, and then performs reverse control for the rear wheel steering device in Step S845. Finally, if it is determined that the front and rear wheels are maintaining opposite directions in Step S846, the processor may generate the lock resumption signal to resume locking control for the front wheel steering device.

That is, the control method according to the present embodiment may suppress unnecessary steering response by locking the front wheels in an initial situation where the failure occurs in the front wheel steering device, and stably maintain straight or turning traveling based on the rear wheel steering device.

Afterwards, it may detect in real time whether the steering direction of the driver is reversed, and if the steering direction reversal continues for a certain period of time, the front wheel lock may be temporarily deactivated to allow the front wheels to be steered in the opposite direction to the rear wheel steering.

In addition, after the unlocking, the rear wheel steering device may be controlled in the direction opposite to the steering direction of the driver, thereby quickly responding to the direction transition request, and the longitudinal stability of the vehicle may be effectively secured by performing the front wheel locking again at a point when the front and rear wheels stably maintain the opposite steering state. This allows the steering responsiveness and traveling stability of the vehicle to be secured even in emergency situations such as a failure of the front wheel steering device.

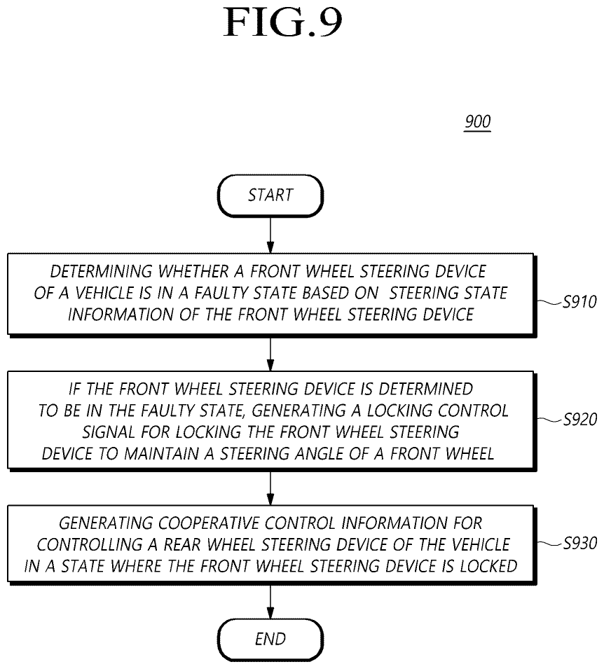

FIG. 9 is an exemplary flowchart illustrating a method for steering assist control 900 according to another embodiment of the present disclosure. The steps illustrated in FIG. 9 may be changed in order as necessary, and at least one step may be omitted or added. The steps in FIG. 9 are merely one embodiment of the present disclosure, and the scope of the rights of the present disclosure is not limited thereto. For features of the contents illustrated in FIG. 9 that overlap with the features described above with respect to FIGS. 1 to 8, reference should be made to the contents described in FIGS. 1 to 8, and their descriptions will be omitted herein.

According to one embodiment of the present disclosure, the method for steering assist control may include Step S910 of determining whether a front wheel steering device of a vehicle is in a faulty state based on steering state information of the front wheel steering device.

According to one embodiment of the present disclosure, the method for steering assist control may include Step S920 of if the front wheel steering device is determined to be in the faulty state, generating a locking control signal for locking the front wheel steering device to maintain a steering angle of a front wheel.

In an embodiment, the locking control signal may include an element control signal for controlling the switch element included in the driver of the front wheel steering device to a conductive state.

In addition, in the embodiment, the step of generating the locking control signal may include transmitting the element control signal to the driving device corresponding to the switch element.

According to one embodiment of the present disclosure, the method for steering assist control may include Step S930 of generating cooperative control information for controlling a rear wheel steering device of the vehicle in a state where the front wheel steering device is locked.

In addition, in the embodiment, the step of generating the cooperative control information may include a step of classifying a traveling situation of the vehicle based on steering angle information of the vehicle and a step of generating the cooperative control information for controlling the rear wheel steering device depending on the classified traveling situation.

In addition, in an embodiment, the step of classifying the traveling situation includes a step of if an absolute value of a steering angle of the vehicle is less than a first threshold, classifying the traveling situation of the vehicle as a straight-line traveling situation and a step of if the absolute value of the steering angle of the vehicle is equal to or more than the firsst threshold and less than a second threshold, classifying the traveling situation of the vehicle as a turning radius maintenance situation.

In addition, in an embodiment, the step of generating the cooperative control information may includes, if the traveling situation of the vehicle is classified as the straight-line traveling situation, generating the cooperative control information for controlling the rear wheel steering device to correspond to a steering direction input by a driver.

In addition, in an embodiment, the step of generating the cooperative control information includes, if the traveling situation is classified as the turning radius maintenance situation, generating the cooperative control information for controlling the rear wheel steering device to correspond to a steering direction input by a driver, acquiring steering speed information of a steering wheel in a cooperative control process corresponding to the cooperative control information, determining whether the steering direction input by the driver is reversed based on the steering speed information of the steering wheel, and generating subsequent cooperative control information to correspond to reversal of the steering direction input by the driver if it is determined that the steering direction input by the driver is reversed. In one embodiment, the steering speed information of the steering wheel includes information on a rotation direction and a rotation speed of the steering wheel.

In addition, in an embodiment, the step of determining whether the steering direction of the driver is reversed includes the determining of whether the steering direction input by the driver is reversed includes determining whether the steering direction input by the driver is reversed based on whether a sign of the steering speed information of the steering wheel is transitioned from positive to negative or from negative to positive.

In addition, in an embodiment, the step of generating the subsequent cooperative control information includes generating an unlocking signal for temporarily deactivating the locking of the front wheel steering device if it is determined that the steering direction input by the driver is reversed, generating the subsequent cooperative control information for controlling the rear wheel steering device in a direction opposite to the steering direction input by the driver, and generating a locking resumption signal for resuming the locking of the front wheel steering device if it is determined that a steering direction of the front wheel steering device becomes opposite to a steering direction of the rear wheel steering device.

In addition, in an embodiment, the step of generating the locking resumption signal may include a step of determining that the front wheel steering device has reached the steering state in the opposite direction to the rear wheel steering device if it is determined that the signs of the steering angle of the front wheel steering device and the steering angle of the rear wheel steering device are opposite to each other and that the difference in the absolute values corresponding to each steering angle is equal to or more than the preset reference value.

A vehicle control system according to another embodiment of the present disclosure may include a steering wheel, a front wheel steering device, a rear wheel steering device, a front wheel steering sensor, a rear wheel steering sensor, a steering wheel sensor, and an apparatus for steering assist control. The above-described components are merely examples according to one embodiment, and the system may further include various additional components or may be configured by omitting some components depending on a specific implementation aspect.

For example, an inertial measurement unit (IMU) for collecting lateral acceleration and yaw rate information of the vehicle may be further included. In addition, for example, a speed sensor for collecting speed information of the vehicle or a GPS module for determining the location and path of the vehicle may be further included. As an additional example, essential control modules and network configurations such as an engine control unit (ECU), a braking control unit (for example, ABS, ESC, or the like), a power distribution unit, and a communication module (for example, CAN communication, Ethernet, or the like) of the vehicle may also be included as parts of the vehicle control system. Although these components are not directly related to the steering assist control of the present disclosure, they are essential elements for performing driving and safety control of the entire vehicle, and may implement a more stable and reliable vehicle control system through mutual linkage. Therefore, the vehicle control system according to the present disclosure is not limited to specific components and may be implemented by flexibly combining with various sensors and control devices.

In an embodiment, the steering wheel may play a role of mechanically transmitting the steering input of the driver. The steering wheel is rotated left and right according to the driver's intention, and the rotation information may be reflected in the steering control of the vehicle.

In addition, the vehicle control system may include the front wheel steering device for steering the front wheels and the rear wheel steering device for steering the rear wheels. The front wheel steering device is a configuration that changes the steering angle of the front wheels in conjunction with the rotation of the steering wheel, and may include, for example, a mechanical or electromechanical (EPS) type actuator. The rear wheel steering device includes a configuration for independently controlling the steering angle of the rear wheel, and for example, an electric actuator may be driven to steer the rear wheel in-phase or reverse phase depending on the traveling situation of the vehicle or the steering input.

In addition, the vehicle control system may include the front wheel steering sensor for detecting the steering state of the front wheel steering device and the rear wheel steering sensor for detecting the steering state of the rear wheel steering device. Each steering sensor measures the steering angle of the corresponding steering device in real time and provides the measured value to the apparatus for steering assist control so that the measured value may be utilized in the steering control algorithm.

In addition, the vehicle control system may include the steering wheel sensor for detecting the steering direction and steering speed of the steering wheel. The steering wheel sensor may identify the steering intention of the driver in real time and reflect the steering intention in the control of the front and rear wheel steering devices.

In addition, the vehicle control system may include the apparatus for steering assist control that communicates with the front wheel steering sensor, the rear wheel steering sensor, and the steering wheel sensor and performs steering assist control.

As described with reference to FIGS. 1 to 9, if a failure occurs in the front wheel steering device, the apparatus for steering assist control locks or unlocks the steering angle of the front wheels and performs the cooperative control using the rear wheel steering device to stably maintain the straight or turning traveling of the vehicle. In addition, the apparatus for steering assist control may comprehensively control the steering state of the entire vehicle so as to simultaneously secure the steering responsiveness and traveling stability through procedures such as detecting in real time whether the steering direction is reversed and temporarily deactivating or resuming the front wheel locking under certain conditions.

The subject matter and the operations described in this specification can be implemented in digital electronic circuitry or in computer software, firmware, or hardware, including the structures disclosed in this specification and their structural equivalents, or in combinations of one or more of them. The subject matter described in this specification can be implemented as one or more computer programs, for example, one or more circuits of computer program instructions, encoded on one or more computer storage media for execution by, or to control the operation of, data processing apparatuses. Alternatively or in addition, the program instructions can be encoded on an artificially generated propagated signal, for example, a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial-access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (for example, multiple CDs, disks, or other storage devices). The operations described in this specification can be implemented as operations performed by a data processing apparatus on data stored on one or more computer-readable storage devices or received from other sources.

The above description has been presented to enable any person skilled in the art to make and use the technical idea of the present disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the present disclosure. The above description and the accompanying drawings provide an example of the technical idea of the present disclosure for illustrative purposes only. That is, the disclosed embodiments are intended to illustrate the scope of the technical idea of the present disclosure. Thus, the scope of the present disclosure is not limited to the embodiments illustrated, but is to be accorded the widest scope consistent with the claims.

What is claimed is:

1. An apparatus for steering assist control, the apparatus comprising:
one or more processors; and
memory configured to store instructions that when executed on the one or more processors cause the one or more processors to perform operations comprising:
determining whether a front wheel steering device of a vehicle is in a faulty state based on steering state information of the front wheel steering device,
if the front wheel steering device is determined to be in the faulty state, generating a locking control signal for locking the front wheel steering device to maintain a steering angle of a front wheel, and
generating cooperative control information for controlling a rear wheel steering device of the vehicle in a state where the front wheel steering device is locked.

2. The apparatus of claim 1, further comprising a motor controller configured to lock the front wheel steering device in response to the locking control signal,
wherein the motor controller is configured to control the front wheel steering device to form an electrical resistance between drive motor terminals of the front wheel steering device according to electrical control and control a steering position of the front wheel to be maintained by a rotational resistance generated through the electrical resistance between the drive motor terminals of the front wheel steering device.

3. The apparatus of claim 1, wherein:
the locking control signal includes an element control signal for controlling a switch element included in a driver of the front wheel steering device to be a conductive state, and
the operations comprise transmitting the element control signal to a driving device corresponding to the switch element.

4. The apparatus of claim 1, wherein the operations comprise classifying a traveling situation of the vehicle based on steering angle information of the vehicle, and generating the cooperative control information for controlling the rear wheel steering device depending on the classified traveling situation.

5. The apparatus of claim 4, wherein the operations comprise:
if an absolute value of a steering angle of the vehicle is less than a first threshold, classifying the traveling situation of the vehicle as a straight-line traveling situation, and
if the absolute value of the steering angle of the vehicle is equal to or more than the first threshold and less than a second threshold, classifying the traveling situation of the vehicle as a turning radius maintenance situation.

6. The apparatus of claim 5, wherein the operations comprise, if the traveling situation of the vehicle is classified as the straight-line traveling situation, generating the cooperative control information for controlling the rear wheel steering device to correspond to a steering direction input by a driver.

7. The apparatus of claim 5, wherein the operations comprise:
if the traveling situation is classified as the turning radius maintenance situation, generating the cooperative control information for controlling the rear wheel steering device to correspond to a steering direction input by a driver,
acquiring steering speed information of a steering wheel in a cooperative control process corresponding to the cooperative control information,
determining whether the steering direction input by the driver is reversed based on the steering speed information of the steering wheel, and
generating subsequent cooperative control information to correspond to reversal of the steering direction input by the driver if it is determined that the steering direction input by the driver is reversed.

8. The apparatus of claim 7, wherein:
the steering speed information of the steering wheel includes information on a rotation direction and a rotation speed of the steering wheel, and
the operations comprise determining whether the steering direction input by the driver is reversed based on whether a sign of the steering speed information of the steering wheel is transitioned from positive to negative or from negative to positive.

9. The apparatus of claim 7, wherein the operations comprise:
generating an unlocking signal for temporarily deactivating the locking of the front wheel steering device if it is determined that the steering direction input by the driver is reversed,
generating the subsequent cooperative control information for controlling the rear wheel steering device in a direction opposite to the steering direction input by the driver, and
generating a locking resumption signal for resuming the locking of the front wheel steering device if it is determined that a steering direction of the front wheel steering device becomes opposite to a steering direction of the rear wheel steering device.

10. The apparatus of claim 9, wherein the operations comprise:
determining that the steering direction of the front wheel steering device becomes opposite to the steering direction of the rear wheel steering device if a sign of a steering angle of the front wheel steering device and a sign of a steering angle of the rear wheel steering device are opposite to each other and a difference between an absolute value of the steering angle of the front wheel device and an absolute value of the steering angle of the rear wheel device is equal to or more than a preset reference value.

11. A method performed by at least one processor included in an apparatus for steering assist control, the method comprising:
determining whether a front wheel steering device of a vehicle is in a faulty state based on steering state information of the front wheel steering device;
if the front wheel steering device is determined to be in the faulty state, generating a locking control signal for locking the front wheel steering device to maintain a steering angle of a front wheel; and
generating cooperative control information for controlling a rear wheel steering device of the vehicle in a state where the front wheel steering device is locked.

12. The method of claim 11, wherein the apparatus for steering assist control includes a motor controller configured to lock the front wheel steering device in response to the locking control signal, and
the motor controller is configured to control the front wheel steering device to form an electrical resistance between drive motor terminals of the front wheel steering device according to electrical control and control a steering position of the front wheel to be maintained by a rotational resistance generated through the electrical resistance between the drive motor terminals of the front wheel steering device.

13. The method of claim 11, wherein:
the locking control signal includes an element control signal for controlling a switch element included in a driver of the front wheel steering device to be a conductive state, and
the generating of the locking control signal includes transmitting the element control signal to a driving device corresponding to the switch element.

14. The method of claim 11, wherein the generating of the cooperative control information includes:
classifying a traveling situation of the vehicle based on steering angle information of the vehicle, and
generating the cooperative control information for controlling the rear wheel steering device depending on the classified traveling situation.

15. The method of claim 14, wherein the classifying of the traveling situation includes:
if an absolute value of a steering angle of the vehicle is less than a first threshold, classifying the traveling situation of the vehicle as a straight-line traveling situation, and
if the absolute value of the steering angle of the vehicle is equal to or more than the first threshold and less than a second threshold, classifying the traveling situation of the vehicle as a turning radius maintenance situation.

16. The method of claim 15, wherein the generating of the cooperative control information includes, if the traveling situation of the vehicle is classified as the straight-line traveling situation, generating the cooperative control information for controlling the rear wheel steering device to correspond to a steering direction input by a driver.

17. The method of claim 15, wherein the generating of the cooperative control information includes:
if the traveling situation is classified as the turning radius maintenance situation, generating the cooperative control information for controlling the rear wheel steering device to correspond to a steering direction input by a driver,
acquiring steering speed information of a steering wheel in a cooperative control process corresponding to the cooperative control information,
determining whether the steering direction input by the driver is reversed based on the steering speed information of the steering wheel, and
generating subsequent cooperative control information to correspond to reversal of the steering direction input by the driver if it is determined that the steering direction input by the driver is reversed.

18. The method of claim 17, wherein:
the steering speed information of the steering wheel includes information on a rotation direction and a rotation speed of the steering wheel, and
the determining of whether the steering direction input by the driver is reversed includes determining whether the steering direction input by the driver is reversed based on whether a sign of the steering speed information of the steering wheel is transitioned from positive to negative or from negative to positive.

19. The method of claim 17, wherein the generating of the subsequent cooperative control information includes:
generating an unlocking signal for temporarily deactivating the locking of the front wheel steering device if it is determined that the steering direction input by the driver is reversed,
generating the subsequent cooperative control information for controlling the rear wheel steering device in a direction opposite to the steering direction input by the driver, and
generating a locking resumption signal for resuming the locking of the front wheel steering device if it is determined that a steering direction of the front wheel steering device becomes opposite to a steering direction of the rear wheel steering device.

20. A vehicle control system, comprising:
a steering wheel configured to mechanically transmit steering input of a driver;
a front wheel steering device configured to steer a front wheel;
a rear wheel steering device configured to steer a rear wheel;
a front wheel steering sensor configured to detect a steering state of the front wheel steering device;
a rear wheel steering sensor configured to detect a steering state of the rear wheel steering device;
a steering wheel sensor configured to detect a steering direction and a steering speed of the steering wheel; and
an apparatus communicationally connected with the front wheel steering sensor, the rear wheel steering sensor, and the steering wheel sensor and configured to perform steering assist control,
wherein the apparatus for the steering assist control is configured to determine whether the front wheel steering device is in a faulty state based on steering state information of the front wheel steering device, generate a locking control signal for locking the front wheel steering device to maintain a steering angle of the front wheel if the front wheel steering device is determined to be in the faulty state, and generate cooperative control information for controlling the rear wheel steering device in a state where the front wheel steering device is locked.
